(19) United States
(12) Patent Application Publication
(10) Pub. No.: US 2015/0111728 A1
(43) Pub. Date: Apr. 23, 2015

(54) Method of Fabricating Honeycomb Catalyst of Nano Metal Oxides for Natural Gas Reforming

(71) Applicant: Institute of Nuclear Energy Research, Atomic Energy Council, Executive Yuan, R.O.C., Taoyuan County (TW)

(72) Inventors: Ning-Yih Hsu, Keelung City (TW); Yuan-Ming Chang, New Taipei City (TW); Kuan-Hsiang Chen, Taichung City (TW); Ruey-Yi Lee, Taoyuan County (TW)

(73) Assignee: Institute of Nuclear Energy Research, Atomic Energy Council, Executive Yuan, R.O.C., Taoyuan County (TW)

(21) Appl. No.: 14/058,362

(22) Filed: Oct. 21, 2013

(51) Int. Cl. B01J 23/63

(52) U.S. Cl. CPC B01J 23/63
USPC 502/304

(57) ABSTRACT

A honeycomb catalyst is fabricated. The catalyst is made of nano metal oxides. The catalyst is used for natural gas reforming. The present invention can be applied in related fields of fuel cells and fuel power systems. The catalyst thus fabricated can be mass-produced, obtain low resistance, enhance surface activity, reduce carbon deposition, improve product performance and prolong use life.

### TECHNICAL FIELD OF THE INVENTION

The present invention relates to fabricating a catalyst for natural gas reforming, where the present invention can be applied in related fields of fuel cells and fuel power systems; and the catalyst thus fabricated can be mass-produced, obtain low resistance, enhance surface activity, reduce carbon deposition, improve product performance and prolong use life.

### DESCRIPTION OF THE RELATED ARTS

Clean and new power resource is an urgent need today owing to high oil price, expensive electricity price, not to mention the need for environmental protection. Solid oxide fuel cell (SOFC) is one of the solutions for its high power generating performance and low CO₂ emission.

A prior art of SOFC uses a nickel-based catalyst. Yet, problems of carrier powdering and carbon deposition would happen after reforming reaction.

Another prior art puts a few granules of catalyst in a round tube to form a packed bed reactor for ease in use. However, a big pressure drop may be easily caused on passing gas, especially when small catalyst granules are used or the gas flows fast. As a result, the packed bed reactor is not fit for SOFC to handle a big flow of gas.

Hence, the prior arts do not fulfill all users' requests on actual use.

### SUMMARY OF THE INVENTION

The main purpose of the present invention is to fabricate a catalyst for natural gas reforming, where the present invention can be applied in related fields of fuel cells and fuel power systems; and the catalyst thus fabricated can be mass-produced, obtain low resistance, enhance surface activity, reduce carbon deposition, improve product performance and prolong use life.

To achieve the above purpose, the present invention is a method of fabricating a honeycomb catalyst of nano metal oxides for natural gas reforming, comprising steps of: (a) preparing honeycomb α-Al₂O₃ catalyst carrier, where a honeycomb aluminum oxide of γ-Al₂O₃ is put in a furnace to be processed through calcination with air and, then, temperature is lowered to obtain a honeycomb catalyst carrier of α-Al₂O₃; (b) preparing cerium nitrate solution, where cerium nitrate (Ce(NO₃)₃.6H₂O) is obtained to be dissolved into de-ionized water to obtain a cerium nitrate solution; (c) impregnating and staying still, where the honeycomb catalyst of α-Al₂O₃ and the cerium nitrate solution are impregnated and stayed still with reaction; (d) dehydrating, where, after the honeycomb catalyst of α-Al₂O₃ is reacted with the cerium nitrate solution, dehydration is processed by using a high-pressure air to blow out leftover water to obtain a honeycomb material of CeO₂/α-Al₂O₃; (e) drying, where the dehydrated honeycomb material of CeO₂/α-Al₂O₃ is dried by an oven; (f) calcining, where the dried honeycomb material of CeO₂/α-Al₂O₃ is put in a furnace to be processed through calcination with air; (g) preparing platinum (Pt) solution, where chloroplatinic acid is obtained to be dissolved into de-ionized water to obtain a Pt solution; (h) impregnating and staying still again, where the calcined honeycomb material of CeO₂/α-Al₂O₃ and the Pt solution are impregnated and stayed still with reaction; (i) dehydrating and drying, where the honeycomb material of CeO₂/α-Al₂O₃ impregnated with the Pt solution is dehydrated by a high-pressure air to blow out leftover water and, then, is dried by an oven; and (j) fabricating honeycomb catalyst of Pt/CeO₂/α-Al₂O₃, where, after the honeycomb material of CeO₂/α-Al₂O₃ is reacted with the Pt solution, calcination is processed with air by using a furnace and, then, temperature is lowered to a room temperature to obtain a honeycomb catalyst of Pt/CeO₂/α-Al₂O₃. Accordingly, (a) novel method of fabricating a honeycomb catalyst of nano metal oxides for natural gas reforming is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention; and

FIG. 2 is the view showing the honeycomb catalyst of Pt/CeO₂/α-Al₂O₃.

### DESCRIPTION OF THE PREFERRED EMBODIMENT

The following description of the preferred embodiment is provided to understand the features and the structures of the present invention.

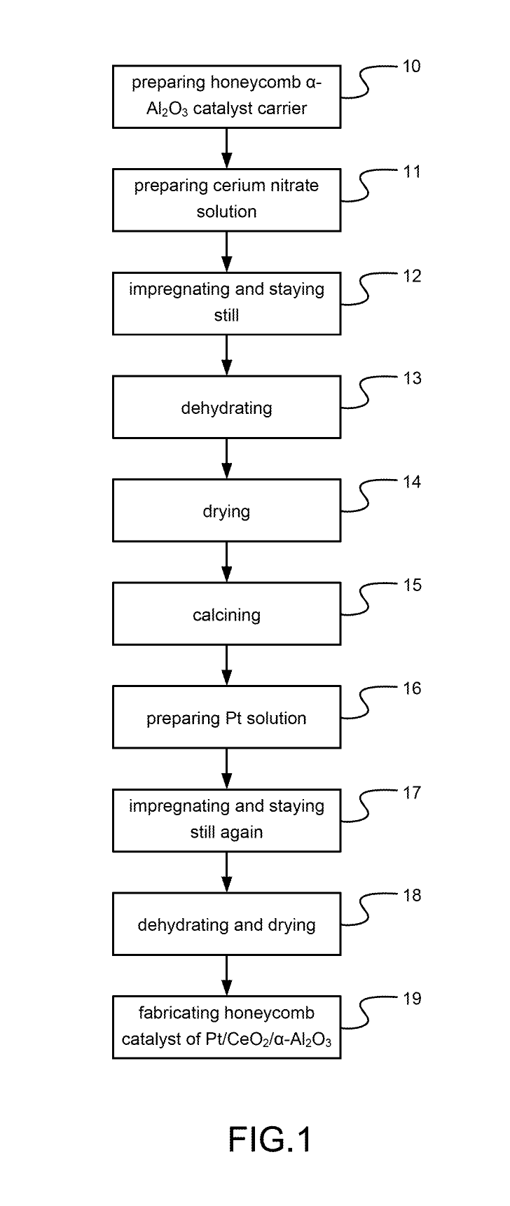

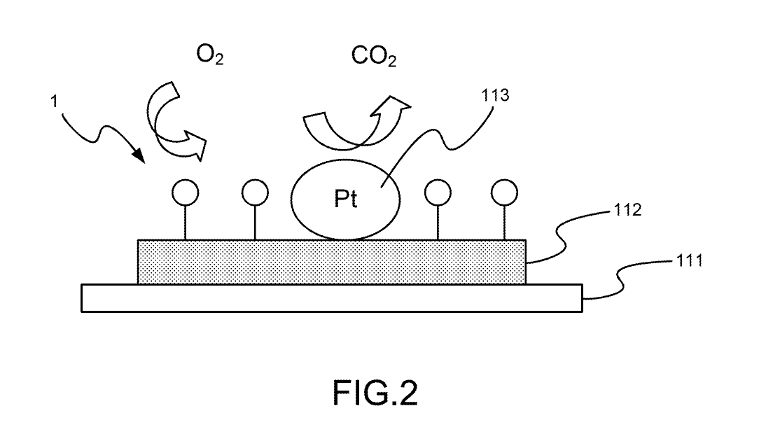

Please refer to FIG. 1 and FIG. 2, which are a flow view showing the preferred embodiment according to the present invention and a view showing a honeycomb catalyst of Pt/CeO₂/α-Al₂O₃. As shown in the figures, the present invention is a method of fabricating a honeycomb catalyst of nano metal oxides for natural gas reforming, comprising the following steps:

(a) Preparing honeycomb α-Al₂O₃ catalyst carrier 10: A honeycomb aluminum oxide of γ-Al₂O₃ is put in a furnace. Then, calcination is processed in the furnace for 6˜9 hours (hrs) with 3 LPM (liters per minute) of air at a temperature of 1080˜1320 Celsius degrees (° C.) under a heating rate of 5° C. per minute (° C./min) for obtaining a honeycomb catalyst carrier of α-Al₂O₃. A preferred state-of-use is to process calcination at 1200° C. for 8 hrs.

(b) Preparing cerium nitrate solution 11: 1.8 grams (g) of cerium nitrate (Ce(NO₃)₃.6H₂O) is dissolved in 50 g of de-ionized water for obtaining a cerium nitrate solution.

(c) Impregnating and staying still 12: The honeycomb catalyst of α-Al₂O₃ and the cerium nitrate solution are impregnated and stayed still with reaction for 12 hrs.

(d) Dehydrating 13: After the honeycomb catalyst of α-Al₂O₃ is reacted with the cerium nitrate solution, dehydration is processed by using a high-pressure air to blow out leftover water for obtaining a honeycomb material of CeO₂/α-Al₂O₃.

(e) Drying 14: The dehydrated honeycomb material of CeO₂/α-Al₂O₃ is put in an oven to be dried at 110° C. for 24 hrs.

(f) Calcining 15: The dried honeycomb material of CeO₂/α-Al₂O₃ is put in a furnace to be processed through calcination for 3˜5 hrs with 3 LPM of air at a temperature of 440˜660° C. under a heating rate of 5° C./min. A preferred state-of-use is to process calcination at 550° C. for 4 hrs.

(g) Preparing platinum (Pt) solution 16: 2.125 g of chloroplatinic acid is dissolved into 50 g of de-ionized water to obtain a Pt solution.

(h) Impregnating and staying still again 17: The calcined honeycomb material of CeO₂/α-Al₂O₃ and the Pt solution are impregnated and stayed still with reaction for 12 hrs.

(i) Dehydrating and drying 18: The honeycomb material of CeO₂/α-Al₂O₃ impregnated with the Pt solution is dehydrated by a high-pressure air to blow out leftover water and, then, is dried by an oven at 110° C. for 24 hrs.

(j) Fabricating honeycomb catalyst of Pt/CeO₂/α-Al₂O₃ 19: After the honeycomb material of CeO₂/α-Al₂O₃ is reacted with the Pt solution, calcination is processed for 3hrs by using a furnace with 3 LPM of air at a temperature of 520˜780° C. under a heating rate of 5° C./min. Then, temperature is lowered to a room temperature to obtain a honeycomb catalyst of Pt/CeO₂/α-Al₂O₃ (as shown in FIG. 2). A preferred state-of-use is to process calcination at 650° C. for 4 hrs. Therein, the honeycomb catalyst of Pt/CeO₂/α-Al₂O₃ has durability over 1000 hrs and a conversion rate more than 99 percents.

Thus, a novel method of fabricating a honeycomb catalyst of nano metal oxides for natural gas reforming is obtained.

The honeycomb catalyst of Pt/CeO₂/α-Al₂O₃ 1 contains α-Al₂O₃ 111, CeO₂ 112 and Pt 113, which is fabricated through steps of preparing honeycomb catalyst carrier of α-Al₂O₃ 10, preparing cerium nitrate solution 11, impregnating 12, dehydrating 13, drying 14, calcining 15, preparing Pt solution 16, impregnating and staying still again 17, dehydrating and drying 18 and fabricating honeycomb catalyst of Pt/CeO₂/α-Al₂O₃ 19. Thus, the honeycomb catalyst of nano metal oxides fabricated according to the present invention can be mass-produced, obtain low resistance, enhance surface activity, reduce carbon deposition, improve product performance and prolong use life.

To sum up, the present invention is a method of fabricating a honeycomb catalyst of nano metal oxides for natural gas reforming, where the present invention can be applied in related fields of fuel cells and fuel power systems; and the honeycomb catalyst of nano metal oxides fabricated according to the present invention can be mass-produced, obtain low resistance, enhance surface activity, reduce carbon deposition, improve product performance and prolong use life.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a honeycomb catalyst of nano metal oxides for natural gas reforming, comprising steps of:
(a) preparing honeycomb α-Al₂O₃ catalyst carrier,
wherein a honeycomb aluminum oxide of γ-Al₂O₃ is put in a furnace to be processed through calcination with air and, then, temperature is lowered to obtain a honeycomb catalyst carrier of α-Al₂O₃;
(b) preparing cerium nitrate solution,
wherein cerium nitrate (Ce(NO₃)₃.6H₂O) is obtained to be dissolved into de-ionized water to obtain a cerium nitrate solution;
(c) impregnating and staying still,
wherein said honeycomb catalyst of α-Al₂O₃ and said cerium nitrate solution are impregnated and stayed still with reaction;
(d) dehydrating,
wherein, after said honeycomb catalyst of α-Al₂O₃ is reacted with said cerium nitrate solution, dehydration is processed by using a high-pressure air to blow out leftover water to obtain a honeycomb material of CeO₂/α-Al₂O₃;
(e) drying,
wherein said dehydrated honeycomb material of CeO₂/α-Al₂O₃ is dried by an oven;
(f) calcining,
wherein said dried honeycomb material of CeO₂/α-Al₂O₃ is put in a furnace to be processed through calcination with air;
(g) preparing platinum (Pt) solution,
wherein chloroplatinic acid is obtained to be dissolved into de-ionized water to obtain a Pt solution;
(h) impregnating and staying still again,
wherein said calcined honeycomb material of CeO₂/α-Al₂O₃ and said Pt solution are impregnated and stayed still with reaction;
(i) dehydrating and drying,
wherein said honeycomb material of CeO₂/α-Al₂O₃ impregnated with said Pt solution is dehydrated by a high-pressure air to blow out leftover water and, then, is dried by an oven; and
(j) fabricating honeycomb catalyst of Pt/CeO₂/α-Al₂O₃,
wherein, after said honeycomb material of CeO₂/α-Al₂O₃ is reacted with said Pt solution, calcination is processed with air by using a furnace and, then, temperature is lowered to a room temperature to obtain a honeycomb catalyst of Pt/CeO₂/α-Al₂O₃.

2. The method according to claim 1,
wherein, in step (a), calcination is processed for 6˜9 hours (hrs) with 3 LPM (liters per minute) of air at a temperature of 1080˜1320 Celsius degrees (° C.) under a heating rate of 5° C. per minute (° C./min).

3. The method according to claim 1,
wherein, in step (b), 1.8 grams (g) of cerium nitrate is dissolved in 50 g of de-ionized water to obtain said cerium nitrate solution.

4. The method according to claim 1,
wherein, in step (c), impregnating and staying still is processed for 12 hrs.

5. The method according to claim 1,
wherein, in step (e), drying is processed at 110° C. for 24 hrs with said oven.

6. The method according to claim 1,
wherein, in step (f), calcination is processed for 3˜5 hrs with 3 LPM of air at a temperature of 440˜660° C. under a heating rate of 5° C./min.

7. The method according to claim 1,
wherein, in step (g), 2.125 g of chloroplatinic acid is dissolved into 50 g of de-ionized water to obtain said Pt solution.

8. The method according to claim 1,
wherein, in step (h), impregnating and staying still is processed for 12 hrs.

9. The method according to claim 1,
wherein, in step (i), dehydrating and drying is processed for 24 hrs with said oven.

10. The method according to claim 1,
wherein, in step (j), calcination is processed for 3˜5 hrs with 3 LPM of air at a temperature of 520˜780° C. under a heating rate of 5° C./min.

11. The method according to claim 1,
wherein said honeycomb catalyst of Pt/CeO₂/α-Al₂O₃ has durability over 1000 hrs and a conversion rate more than 99 percents.
